(19) United States
(12) Patent Application Publication
(10) Pub. No.: US 2012/0189369 A1
(43) Pub. Date: Jul. 26, 2012

(54) KEYBOARD AND PROTECTIVE COVER THEREOF

(76) Inventor: Chao-Lung Chang, Taoyuan (TW)

(21) Appl. No.: 13/348,600

(22) Filed: Jan. 11, 2012

(30) Foreign Application Priority Data
Jan. 25, 2011 (TW) 100201633

(51) Int. Cl. B41J 5/12

(52) U.S. Cl. 400/490

(57) ABSTRACT

A keyboard includes a base, a plurality of keyswitches and a protective cover. The keyswitches are disposed on the base. Each of the keyswitches includes a key cap. The protective cover includes a plurality of hollow protruding portions and a plurality of surface structures. Each of the surface structures is formed on one of the hollow protruding portions. When the protective cover is disposed on the base, each of the hollow protruding portions covers one of the key caps correspondingly.

### BACKGROUND OF THE INVENTION

1. Field of the Invention

The invention relates to a keyboard and a protective cover thereof and, more particularly, to a protective cover capable of providing pressing feeling.

2. Description of the Prior Art

A keyboard, which is the most common input device, can be found in variety of electronic equipments for users to input characters, symbols, numerals and so on. To prevent the keyboard from being damaged due to external object (e.g. water, dust, etc.), which may enter the keyboard through gaps between key caps, the prior art covers the gaps between the key caps with a protective cover so as to prevent the external object from entering the keyboard through the gaps between the keycaps. However, since the surface of the conventional protective cover corresponding to each keyswitch is always flat, the conventional protective cover cannot provide any pressing feeling for a user except functions of dust-proof and water-proof.

### SUMMARY OF THE INVENTION

Therefore, an objective of the invention is to provide a keyboard and a protective cover thereof capable of providing pressing feeling, so as to solve the aforesaid problems.

According to an embodiment of the invention, a protective cover comprises a plurality of hollow protruding portions and a plurality of surface structures. Each of the surface structures is formed on one of the hollow protruding portions. In this embodiment, each of the surface structures maybe recess structure, protruding structure, uneven structure, Braille structure or texture structure.

According to another embodiment of the invention, a keyboard comprises a base, a plurality of keyswitches and the aforesaid protective cover. The keyswitches are disposed on the base. Each of the keyswitches comprises a key cap. When the protective cover is disposed on the base, each of the hollow protruding portions covers one of the key caps correspondingly.

As mentioned in the above, the invention forms specific surface structures (e.g. recess structure, protruding structure, uneven structure, Braille structure, texture structure, etc.) on the hollow protruding portions of the protective cover, so as to provide different pressing feelings or other functions for a user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a keyboard according to an embodiment of the invention.

FIG. 2 is an exploded view illustrating parts of the keyboard shown in FIG. 1.

FIG. 3 is a cross-sectional view illustrating the keyboard along line X-X shown in FIG. 1.

FIG. 4 is a cross-sectional view illustrating parts of a protective cover according to another embodiment of the invention.

FIG. 5 is a cross-sectional view illustrating parts of a protective cover according to another embodiment of the invention.

FIG. 6 is a cross-sectional view illustrating parts of a protective cover according to another embodiment of the invention.

FIG. 7 is a schematic diagram illustrating a protective cover according to another embodiment of the invention.

### DETAILED DESCRIPTION

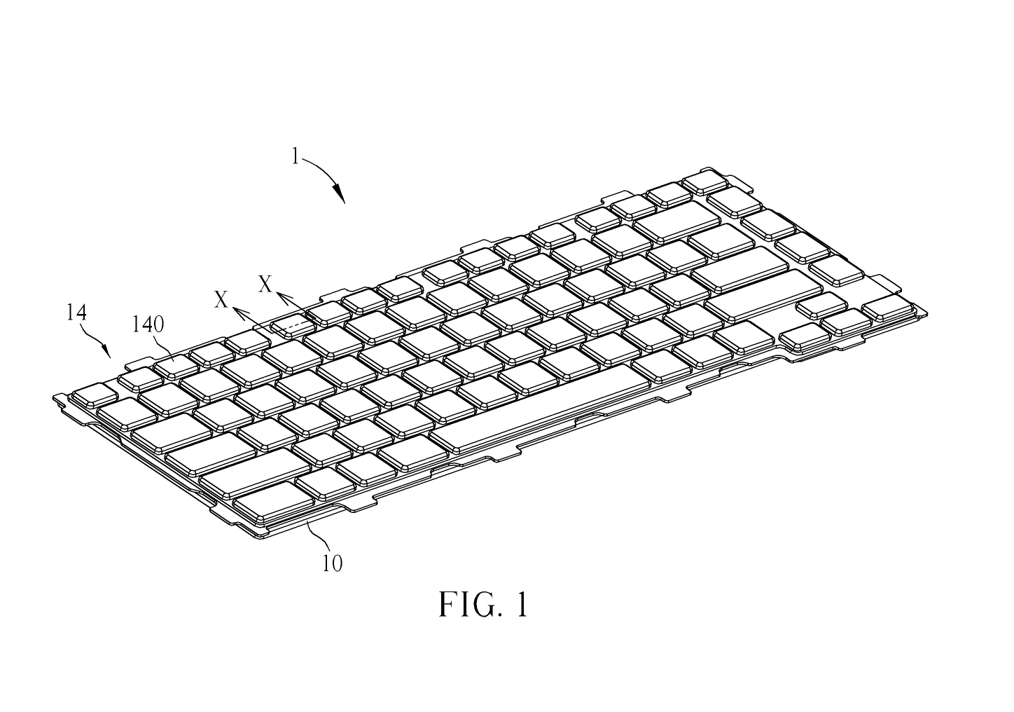

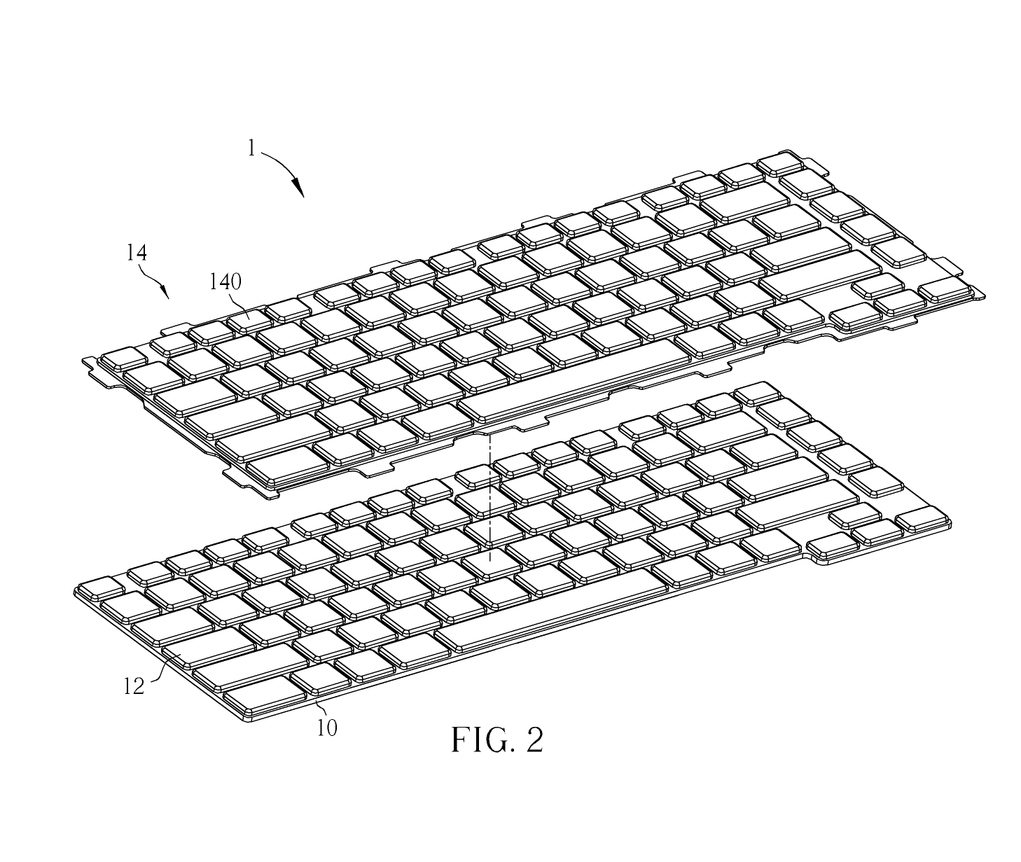

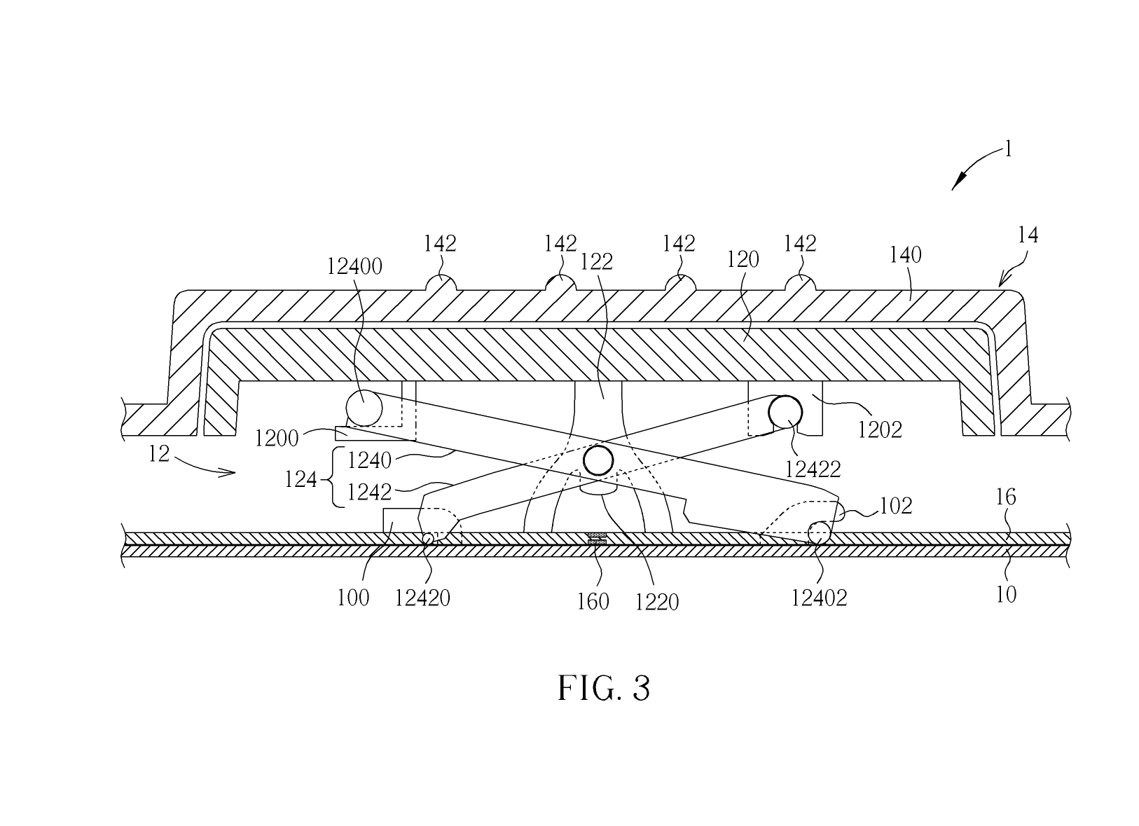

Referring to FIGS. 1 to 3, FIG. 1 is a schematic diagram illustrating a keyboard 1 according to an embodiment of the invention, FIG. 2 is an exploded view illustrating parts of the keyboard 1 shown in FIG. 1, and FIG. 3 is a cross-sectional view illustrating the keyboard 1 along line X-X shown in FIG. 1. As shown in FIGS. 1 to 3, the keyboard 1 comprises a base 10, a plurality of keyswitches 12 and a protective cover 14. The keyswitches 12 are disposed on the base 10 for a user to press so as to execute desired function correspondingly. In this embodiment, the protective cover 14 may be made of, but not limited to, rubber.

As shown in FIG. 3, the keyboard 1 further comprises a circuit board 16 disposed between the base 10 and the keyswitch 12, wherein the circuit board 16 has a plurality of switches 160 (only one switch 160 is shown in FIG. 3) and the keyswitch 12 is corresponding to the switch 160. In practical applications, the circuit board 16 may be, but not limited to, a membrane circuit board and the switch 160 may be, but not limited to, a membrane switch or other trigger-type switch. Furthermore, the keyswitch 12 comprises a key cap 120, a resilient member 122 and a lift support device 124, wherein the resilient member 122 and the lift support device 124 are disposed between the base 10 and the key cap 120. The resilient member 122 may be, but not limited to, a rubber dome. The resilient member 122 is used to provide elastic force while the key cap 120 moves upward and downward with respect to the case 10. Moreover, the resilient member 122 has a trigger portion 1220. When the key cap 120 of the keyswitch 12 is pressed, the trigger portion 1220 of the resilient member 122 triggers the switch 160 of the circuit board 16, so as to execute desired function correspondingly.

In this embodiment, the key cap 120 may have a first sliding groove 1200 and a first engaging groove 1202 and the base 10 may have a second sliding groove 100 and a second engaging groove 102. The lift support device 124 may comprise a first support member 1240 and a second support member 1242, wherein the first support member 1240 is pivotally connected to the second support member 1242. The first support member 1240 may have a first sliding portion 12400 and a first pivoting portion 12402. The second support member 1242 may have a second sliding portion 12420 and a second pivoting portion 12422. The first sliding portion 12400 is slidably disposed in the first sliding groove 1200 and the first pivoting portion 12402 is rotatably disposed in the second engaging groove 102. The second sliding portion 12420 is slidably disposed in the second sliding groove 100 and the second pivoting portion 12422 is rotatably disposed in the first engaging groove 1202. Accordingly, when the key cap 120 of the keyswitch 12 is pressed, the key cap 120 will move toward the base 10 along with the lift support device 124.

As shown in FIGS. 1 to 3, the protective cover 14 comprises a plurality of hollow protruding portions 140 and a plurality of surface structures 142, wherein each of the surface structures 142 is formed on the hollow protruding portion 140 correspondingly. In this embodiment, the surface structures 142 are designed as protruding structures. When a user presses the keyswitch 12 through the protective cover 14, the surface structures 142 on the corresponding hollow protruding portion 140 are capable of massaging finger of the user. Accordingly, the protective cover 14 can provide specific pressing feeling for the user. It should be noted that the size, arrangement and shape of the surface structures 142 can be determined based on practical applications and are not limited to the embodiment shown in FIG. 3. For example, the surface structures 142 may be arranged in specific letter, character, numeral or symbol (e.g. English alphabet, phonetic symbol, directional symbol, etc.) such that the user can identify each of the keyswitches 12 by the surface structures 142. Furthermore, the surface structures 142 may be designed as Braille structures for blind people to identify each of the keyswitches 12.

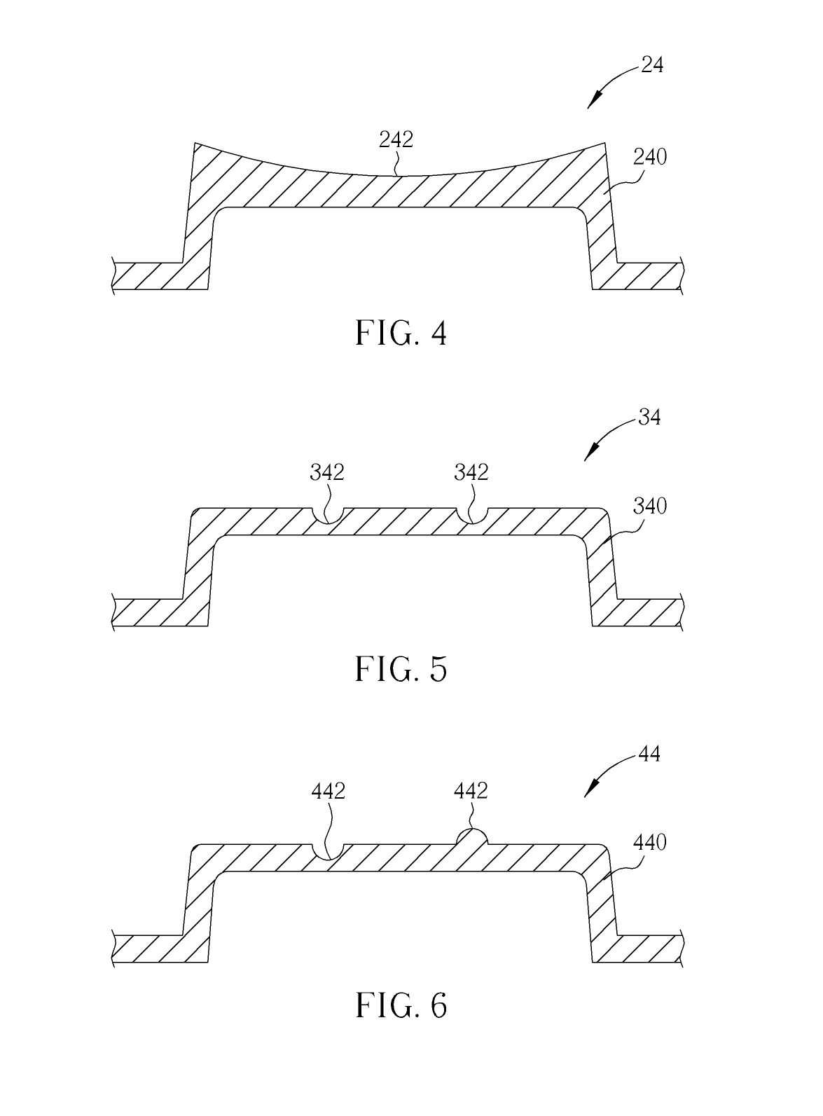

Referring to FIG. 4, FIG. 4 is a cross-sectional view illustrating parts of a protective cover 24 according to another embodiment of the invention. As shown in FIG. 4, the main difference between the protective cover 24 and the aforesaid protective cover 14 is that the surface structure 242 formed on a hollow protruding portion 240 of the protective cover 24 is designed as one single recess structure. In this embodiment, the surface structure 242 may be a recess structure conforming to ergonomics such that the finger of a user can be perfectly fit in the surface structure 242 while pressing the hollow protruding portion 240 of the protective cover 24. Accordingly, the protective cover 24 with the surface structure 242 can prevent the user from feeling tired or uncomfortable after using the keyboard for a long time.

Referring to FIG. 5, FIG. 5 is a cross-sectional view illustrating parts of a protective cover 34 according to another embodiment of the invention. As shown in FIG. 5, the main difference between the protective cover 34 and the aforesaid protective cover 14 is that the surface structures 342 formed on a hollow protruding portion 340 of the protective cover 34 comprises a plurality of recess structures for providing different pressing feelings for a user. Similarly, the size, arrangement and shape of the surface structures 342 can be determined based on practical applications.

Referring to FIG. 6, FIG. 6 is a cross-sectional view illustrating parts of a protective cover 44 according to another embodiment of the invention. As shown in FIG. 6, the main difference between the protective cover 44 and the aforesaid protective cover 14 is that the surface structures 442 formed on a hollow protruding portion 440 of the protective cover 44 comprises a plurality of recess and protruding structures (i.e. uneven structure) for providing different pressing feelings for a user. Similarly, the size, arrangement and shape of the surface structures 442 can be determined based on practical applications.

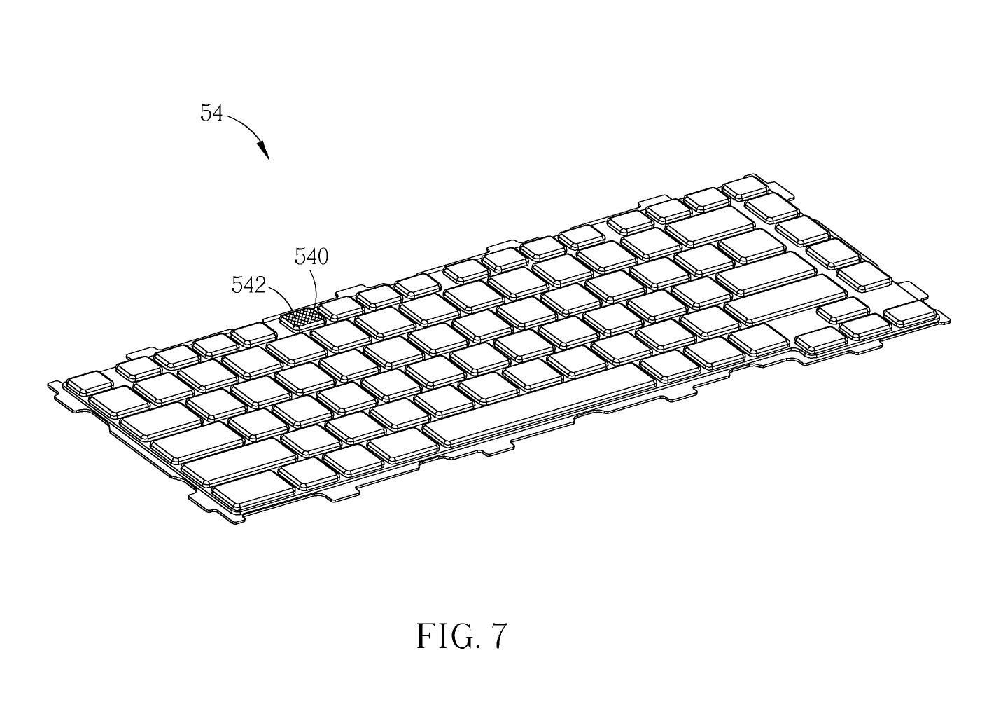

Referring to FIG. 7, FIG. 7 is a schematic diagram illustrating a protective cover 54 according to another embodiment of the invention. As shown in FIG. 7, the main difference between the protective cover 54 and the aforesaid protective cover 14 is that the surface structure 542 formed on a hollow protruding portion 540 of the protective cover 54 is designed as a texture structure for providing different pressing feelings for a user. Especially, the surface structure 542 can increase friction between the finger of the user and the hollow protruding portion 540 of the protective cover 54 while the user presses the keyswitch correspondingly. Similarly, the size, arrangement and shape of the surface structure 542 can be determined based on practical applications.

As mentioned in the above, the invention forms specific surface structures (e.g. recess structure, protruding structure, uneven structure, Braille structure, texture structure, etc.) on the hollow protruding portions of the protective cover, so as to provide different pressing feelings or other functions for a user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard comprising:
a base;
a plurality of keyswitches disposed on the base, each of the keyswitches comprising a key cap; and
a protective cover comprising a plurality of hollow protruding portions and a plurality of surface structures, each of the surface structures being formed on one of the hollow protruding portions, wherein when the protective cover is disposed on the base, each of the hollow protruding portions covers one of the key caps correspondingly.

2. The keyboard of claim 1, wherein each of the surface structures is one selected from a group consisting of: recess structure, protruding structure, uneven structure, Braille structure and texture structure.

3. The keyboard of claim 1, wherein the protective cover is made of rubber.

4. The keyboard of claim 1, further comprising a circuit board disposed between the base and the keyswitches, wherein the circuit board has a plurality of switches and each of the switches is corresponding to one of the keyswitches.

5. The keyboard of claim 1, wherein each of the key switches comprises a resilient member and a lift support device, the resilient member and the lift support device are disposed between the base and the key cap.

6. The keyboard of claim 5, wherein the key cap has a first sliding groove and a first engaging groove, the base has a second sliding groove and a second engaging groove, the lift support device comprises:
a first support member having a first sliding portion and a first pivoting portion, the first sliding portion being slidably disposed in the first sliding groove, the first pivoting portion being rotatably disposed in the second engaging groove; and
a second support member pivotally connected to the first support member, the second support member having a second sliding portion and a second pivoting portion, the second sliding portion being slidably disposed in the second sliding groove, the second pivoting portion being rotatably disposed in the first engaging groove.

7. The keyboard of claim 5, wherein the resilient member is a rubber dome.

8. A protective cover comprising:
a plurality of hollow protruding portions; and
a plurality of surface structures, each of the surface structures being formed on one of the hollow protruding portions.

9. The protective cover of claim 8, wherein each of the surface structures is one selected from a group consisting of: recess structure, protruding structure, uneven structure, Braille structure and texture structure.
